(19) United States
(12) Patent Application Publication
(10) Pub. No.: US 2012/0276992 A1
(43) Pub. Date: Nov. 1, 2012

(54) MOST VALUABLE PLAYER GAMER STATUS AND APPLICATIONS

(75) Inventors: MOHAMMED MOINUDDIN, BELLEVUE, WA (US); JOSEPH FUTTY, SAMMAMISH, WA (US); DAN E. WALTHER, REDMOND, WA (US); SREENIVAS GOLLAPUDI, CUPERTINO, CA (US); DANNY LANGE, SAMMAMISH, WA (US); SRIPRIYA PRASHANTHI VASUDEVAN, ISSAQUAH, WA (US); MILLER THOMAS ABEL, MERCER ISLAND, WA (US); STELIOS PAPARIZOS, SAN JOSE, CA (US); JOHN C. SHAFER, LOS ALTOS, CA (US)

(73) Assignee: MICROSOFT CORPORATION, REDMOND, WA (US)

(21) Appl. No.: 13/095,499

(22) Filed: Apr. 27, 2011

(51) Int. Cl. A63F 13/00

(52) U.S. Cl. 463/31

(57) ABSTRACT

A gaming environment is provided by an MVP gaming system provider in which “most valuable player” (MVP) gamers may compete. MVP gamers may be identified using achievements, gamer scores, game play during sanctioned gaming events, or other indicia of game skills. The MVP gamers may be sponsored by advertisers, and the MVP gamers' avatars may be branded based on sponsorship during gaming events. The sponsorships may be brokered by the MVP gaming system provider. Some gaming events may be sanctioned gaming events that are coordinated by the MVP gaming system provider and “televised” to allow viewers to watch the gaming events. Tutorials from MVP gamers may also be provided to gamers for viewing to assist in their game play. Further, gamers may be able to rent the avatars of MVP gamers for use during their game play.

### BACKGROUND

Gaming inherently provides motivation to achieve personal “bests.” But, in an effort to entertain and increase user commitment to gaming, additional motivation may be awarded. However, it is desired that additional motivation be of minimal resource cost and potentially generate rewards for more than just the users playing games. In some instances, motivation has been provided through the use of achievements. In particular, some electronic gaming systems award achievements to players for performing certain actions or achieving certain goals within particular games. In some cases, the achievements contribute to a gamer score, and gamer profiles for users allow the users to show their achievements and/or gamer score to other users. Despite the success of achievements and other approaches to engaging people in gaming, gaming system providers continue to search for additional opportunities to provide incentives for users to participate in gaming and also open new channels for monetizing the gaming experience.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to a gaming environment with most valuable player (MVP) gamers. MVP gamers are identified via their achievements, gamer scores, game play during sanctioned gaming events, or using other approaches. Advertisers may choose to sponsor certain MVP garners. Based on sponsorship, MVP garners' avatars may be branded during gaming events. Some gaming events may be sanctioned by an MVP gaming system provider and “televised” to allow viewers to watch the gaming events. Tutorials from MVP garners may also be provided for garner access. Further, garners may be able to rent the avatars of MVP garners during the garners' game play.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram showing an environment for providing MVP gaming in accordance with an embodiment of the present invention;

FIG. 3 is a flow diagram showing a method for MVP gaming in accordance with an embodiment of the present invention;

FIG. 4 is a flow diagram showing a method for using achievements and/or gaming scores to identify MVP garners in accordance with an embodiment of the present invention;

FIG. 5 is a flow diagram showing a method for conducting a sanctioned event to identify MVP garners in accordance with an embodiment of the present invention;

FIG. 6 is a flow diagram showing a method for coordinating sponsorship of MVP garners by advertisers in accordance with an embodiment of the present invention;

FIG. 7 is a flow diagram showing a method for coordinating sponsorship offers between advertisers and an MVP garner in accordance with an embodiment of the present invention;

FIG. 8 is a flow diagram showing a method for branding an MVP gamer's avatar during a sanctioned gaming event in accordance with an embodiment of the present invention;

FIG. 9 is a flow diagram showing a method for branding an MVP gamer's avatar during an online non-sanctioned gaming event in accordance with an embodiment of the present invention;

FIG. 10 is a flow diagram showing a method for providing an MVP gamer tutorial in accordance with an embodiment of the present invention; and

FIG. 11 is a flow diagram showing a method for renting an MVP gamer's avatar in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are directed to providing an environment providing by an MVP gaming system providing in which most valuable player (MVP) gamers are identified and sponsored during gaming events. As used herein, an “MVP gamer” refers to a gamer that has been identified as an expert or as having particular skills or level of skill in one or more games. A gamer may have an overall MVP status, an MVP status for a particular game console/system, an MVP status for a category of games, an MVP status for a game series, and/or an MVP status for a particular game title. In some embodiments, MVP gamers may be identified based on achievements and/or gamer score earned by playing various games. In some embodiments, MVP gamers may be identified by conducting sanctioned gaming events in which gamers compete to obtain MVP status. In still further embodiments, MVP gamers may be identified when gamers beat someone who is already an MVP gamer.

MVP gamers may be sponsored by one or more advertisers, and the sponsorship may be brokered by the MVP gaming system provider. The MVP players may be compensated for the sponsorships, and the MVP gaming system provider may be compensated for brokering the sponsorships. Based on sponsorship, an MVP gamer's avatar may be branded during gaming events. These gaming events may include general online gaming in which other gamers may participate and sanctioned gaming events put on by the VP gaming system provider in which only MVP gamers may participate. The sanctioned gaming events may be “televised” to allow viewers to watch the events. This may include an interactive experience in which users may control the viewing perspective and/or other features, such as commentary, may be provided. In some embodiments, specific games may be developed for the sanctioned gaming events that may or may not be available to the general public.

In some embodiments, tutorials from MVP gamers may be created to assist regular gamers. The tutorials may comprise: videos showing MVP gamers playing particular games; interactive gaming sessions between gamers and MVP gamers; use of MVP gamer techniques; or an evaluation tool that evaluates a gamer's game play with respect to MVP gamer game play to provide suggestions. As such, gamers may access particular tutorials of their favorite MVP garners to learn from those MVP garners' game play. The avatars of the MVP gamers may be branded based on sponsorships in the tutorials. In further embodiments, garners may be able to rent MVP garners' avatars for their game play. This may include renting the look, skills, accessories, and/or techniques of the MVP garners' avatars. Branding for sponsor MVP garners' avatars may be included or removed during avatar rental at the sponsors' discretion. The MVP garners may be compensated for their tutorials and avatar rentals.

Accordingly, in one aspect, an embodiment of the present invention is directed to a method for providing a gaming event with MVP garners. The method includes identifying one or more MVP garners. The method also includes identifying a sponsor for a first MVP garner. The method further includes conducting a gaming event with the one or more MVP garners. The method still further includes branding an avatar of the first MVP garner during the gaming event based on the sponsor.

In another embodiment, an aspect of the invention is directed to one or more computer-storage media storing computer-useable instructions that, when used by one or more computing devices, cause the one or more computing devices to perform a method. The method includes providing a plurality of tutorials, each tutorial corresponding with at least one of a plurality of MVP garners. The method also includes receiving, from a viewer, a request for a first tutorial, the first tutorial corresponding with a first MVP garner. The method further includes providing the requested first tutorial to the viewer.

A further embodiment of the present invention is directed to one or more computer-storage media storing computer-useable instructions that, when used by one or more computing devices, cause the one or more computing devices to perform a method. The method includes receiving a user selection of an avatar of a MVP gamer to rent during gaming. The method also includes providing the gamer with the avatar of the MVP gamer during the gaming.

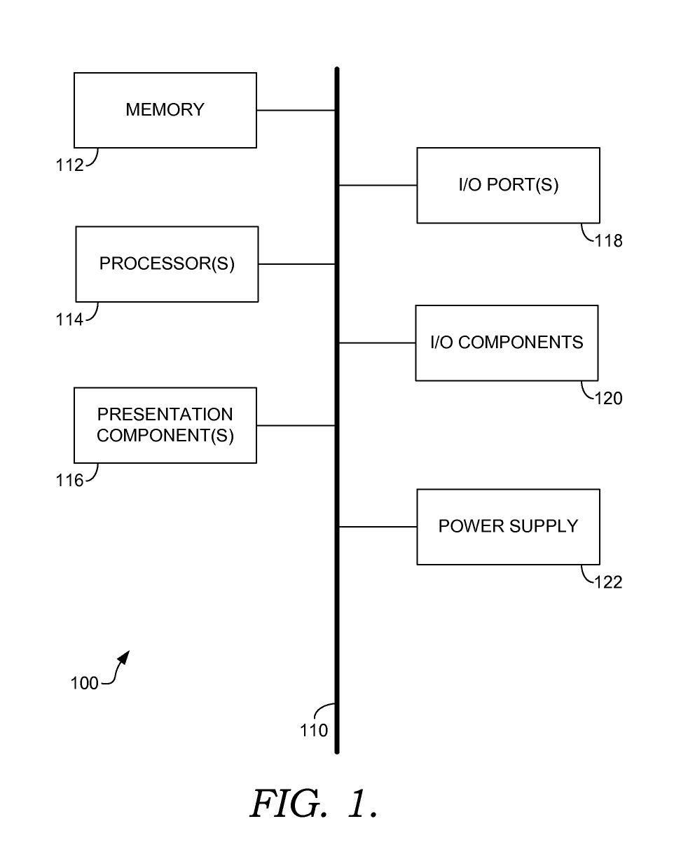

Having briefly described an overview of embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output (I/O) ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

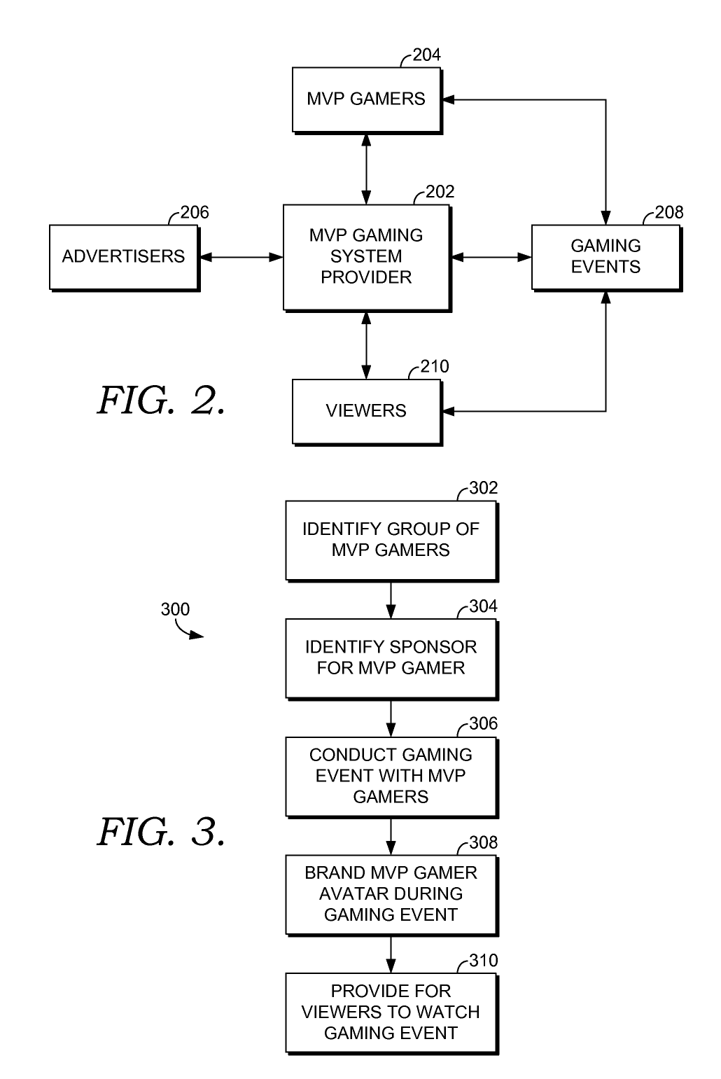

Referring now to FIG. 2, a block diagram is presented that illustrates an environment for an MVP gaming system in accordance with an embodiment of the present invention. As shown in FIG. 2, an MVP gaming system provider 202 operates to provide an environment in which MVP gamers 204 are identified and may be sponsored by advertisers 206, including sponsorship during gaming events 208 in which the MVP gamers 204 participate. As will be described in further detail below, in some embodiments, the gaming events 208 may include sanctioned events coordinated by the MVP gaming system provider 202, and such sanctioned events may be “televised” such that viewers 210 may watch the MVP gamers 204 compete in the gaming events 208. It should be understood that it is contemplated that the MVP gaming system provider 202 and functions thereof described herein may be provided by a single entity or multiple entities in various embodiments of the present invention.

Gamers may be identified and awarded an MVP status in a number of different ways within the scope of embodiments of the present invention. In some embodiments, gamers may be award an MVP status based on their achievements and/or gamer scores from regular game play (e.g., online gaming outside of sanctioned gaming events coordinated by the MVP gaming system provider 202). As is known in the art, achievements are awards earned by users for performing certain actions or achieving certain goals within particular games. In some cases, the achievements are each worth a number of points that contribute to the gamer's gaming score. The achievements earned and/or gaming score for a gamer are typically maintained in a gamer profile for the user. Accordingly, by accessing and analyzing gamers' gamer profiles, the achievements and/or gaming scores may be analyzed and used to identify MVP gamers 204. In further embodiments, other gaming stats may be tracked and employed to identify MVP gamers 204.

MVP status may be awarded to gamers in some embodiments based on their total achievements and/or total gaming score across all games. In other embodiments, however, MVP status may be awarded to gamers in particular categories of games based on achievements earned from such categories of games. For example, a gamer may often play sports games and may have earned a large number of achievements and/or achievement points from those games. As such, the gamer may be identified as an MVP gamer 204 for a sports games category. However, the gamer may not have an MVP status for other game categories, although it's contemplated that a gamer could have MVP status in multiple different categories. As another example, a gamer may often play first-person shooter games, and based on achievements and/or achievement points from those games, the gamer may be awarded MVP status for first-person shooter games. In embodiments in which MVP status is awarded to gamers in different categories, games within each category may be identified, and category gamer scores may be calculated based on achievements from those games.

In some embodiments, MVP status may be awarded within particular game titles or title series. For example, certain gamers may be identified as MVP gamers 204 for the latest HALO game on the XBOX console and/or may be identified as MVP gamers 206 for the HALO game series. These gamers would be identified based on their game play (e.g., achievements earned and/or other gaming stats) from those particular games.

Another approach for identifying MVP gamers 204 may be through the use of sanctioned gaming events coordinated by the MVP gaming system provider 202. In particular, the MVP gaming system provider 202 may hold sanctioned events in which different gamers may participate. Such sanctioned events may allow the MVP gaming system provider 202 to provide tighter controls on the gaming to prevent player-side manipulation and cheats. Gaming statistics and other information may be collected during the sanctioned gaming events to allow for the identification of MVP gamers 204. In some instances, gamers' performance in the sanctioned gaming events may be used in conjunction with their achievements and/or gaming scores from non-sanctioned gaming events to identify MVP gamers 204.

Gamers who may participate in such sanctioned events may be identified in a number of different ways. For instance, in some embodiments, any garner who wishes to participate in a sanctioned gaming event that is held to identify MVP garners 204 may enter the sanctioned gaming event. In some instances, the garners may be required to pay an entry fee or otherwise provide some compensation to the MVP gaming system provider 202 in order to participate. In other embodiments, only certain garners may be eligible to participate in the sanctioned gaming events. For instance, only garners who meet a threshold achievement level or garner score from non-sanctioned gaming events may be eligible to participate. In such embodiments, those garners may be identified by the MVP gaming system provider 202 and invited to participate in the sanctioned gaming events.

In embodiments of the present invention, MVP garners 204 may be sponsored by advertisers 206. Each MVP garner 204 may be sponsored by one or more advertisers 206. The advertisers 206 may include, for instance, various merchants who may or may not be directly involved in the gaming industry but who may desire to market to a gaming audience. Sponsorship of MVP garners 204 by advertisers 206 may be brokered by the MVP gaming system provider 202. In embodiments, the MVP gaming system provider 202 may receive from the advertisers 206 to broker the sponsorships. Additionally, the MVP garners 204 may receive compensation from the MVP gaming system provider 202 and/or from the advertisers 206 for the sponsorship. The compensation may be in the form of money, virtual currency, achievements, electronic gear, early access to new games, coupons, rebates, or other forms of awards or remuneration. When the compensation is in the form of achievements or a similar award that affects gaming status, this may be a way for the MVP garners to further improve their gaming status. This may be in addition to being able to play in a playoff or invite-only type event (e.g., a tournament), which may result in the MVP gamer earning more achievement points.

As part of brokering sponsorships of MVP gamers, the MVP gaming system provider 202 may collect information regarding MVP gamers 204 and provide the information to the advertisers 206. The advertisers 206 may then review the information in order to identify MVP gamers 204 the advertisers 206 would like to sponsor.

A variety of different information regarding the MVP gamers 204 may be provided to the advertisers 206 to allow the advertisers 240 to make informed sponsorship decisions. The information may include both information regarding each MVP gamers' 204 gaming skills. For instance, the information provided to the advertisers may include information regarding the game play of MVP gamers (e.g., achievements earned, gaming score, performance in sanctioned events, and/or other gaming-related stats).

The information provided to advertisers may also include information representative of each MVP gamers' 204 popularity with viewers 210. As will be discussed in further detail below, some embodiments provide for “televising” gaming events 208 in which MVP gamers 204 participate to allow viewers 210 to watch the gaming events 208. In such embodiments, information regarding viewership of each MVP gamer 204 (e.g., number of viewers watching each MVP gamer 204, length of viewing for each MVP gamer 204, etc.) during the gaming events 208 may be collected, and that information may be provided to the advertisers 206. As will also be discussed in further detail below, some embodiments allow for other gamers to access gaming tutorials from MVP gamers. In such embodiments, information regarding gamers' access of tutorials of each MVP player 204 may be collected and provided to advertisers 206. Further, as will be discussed in further detail below, some embodiments allow other garners to rent MVP garners' 204 avatar look, skills, and/or accessories. Information regarding such rental of MVP garners' 204 avatars may be tracked and provided to the advertisers 206.

Sponsorship of an MVP garner 204 by an advertiser 206 may include branding the MVP gamer's 204 avatar with the advertiser's 206 logo or other identifying features or advertising messages associated with the advertiser 206 during gaming events 208. Branding may include, for instance, placing a logo on an avatar's clothing, armor, or gear. If any MVP garner 204 is sponsored by multiple advertisers 206, the MVP gamer's 204 avatar may be branded with logos, features, or messages from the multiple advertisers 206 at the same time in the same gaming event 208 or branding for a single advertiser may be selected for each gaming event 208.

The gaming events 208 in which an MVP gamer's 204 avatar may be branded may include both non-sanctioned gaming events and sanctioned gaming events. Non-sanctioned gaming events may include any online gaming event that may be considered general game play and that may not be coordinated by the MVP gaming system provider. Any garner may participate in these non-sanctioned gaming events. Sanctioned gaming events include gaming events that are specifically coordinated by the MVP gaming system provider for the purpose of providing an MVP gaming experience. The sanctioned events may be limited to only MVP garners and may include tighter controls than regular game play to prevent player-side manipulation and cheats.

The games played during sanctioned gaming events may include games that are generally available to the public for gaming or games that are specifically developed for the sanctioned gaming events, for instance, to provide a type of league play for such gaming events. For example, there may be several football or first-person shooting games that are generally available to the public for gaming systems, but a specific game may be created for each activity specifically for sanctioned gaming events. These games may be designed in a manner that provide for tighter controls or otherwise include features that facilitate competitions amongst MVP gamers. Additionally, these specifically developed games may facilitate league play that allows viewers 210 to watch specific MVP gamers 204, to get real-time updates on the league, to facilitate distribution of achievements based on league competition, or other functionality to support sanctioned events.

If a gamer has MVP status only for a particular category or particular game title or series, in some embodiments, the MVP gamer's avatar may only be branded when the MVP gamer participates in games of that particular category or game title or series. Additionally, in some embodiments, a gamer who has MVP status only for a particular category or particular game title or series may only be allowed to participate in sanctioned gaming events that are directed to that particular category or game title or series.

Gaming events 208 in which MVP gamers 204 participate may be “televised” (e.g., IP-based or traditional cable television) to allow viewers 210 to watch the gaming events 208. This may include televising live and/or past gaming events. Additionally, this may include televising non-sanctioned and/or sanctioned gaming events. The content may be presented at scheduled times or may be available to viewers 210 at an on-demand basis. Viewers may be able to access the gaming events in a variety of different manners, including via their televisions, set-top boxes, computers, gaming consoles, or other devices. For instance, a channel may be created, in some embodiments, that is directed to televising the gaming events 208. However, other approaches for allowing the viewers 210 to access and watch gaming events 208 may be employed within the scope of embodiments of the present invention.

In some embodiments, an interactive experience may be provided to viewers 210 when watching gaming events 208. For instance, viewers 210 may be able to select a particular MVP player to follow, a particular perspective (e.g., player, camera, or combinations) to view the game play, and real-time information related to the gaming event being watched. Additionally, traditional sporting commentary may be supplied to supplement the game play. The system may also provide stats regarding how many people are following each MVP gamer, which may thereby identify the most popular gamer.

As noted above, avatars of sponsored MVP gamers 204 may be branded during the gaming events. In some embodiments, the MVP gamers 204 may view other avatars without the branding during the game play and only viewers 210 would see the branding. In addition to branding avatars, other advertising opportunities may be presented during sanctioned gaming events. For instance, it is contemplated that specific portions of league play or other gaming events (e.g., particular bouts, particular matches, particular games, etc.) may be sponsored by an advertiser 206 that may provide compensation for the sponsorship opportunity to the MVP gaming system provider 202. Additionally, the advertiser 206 may provide compensation to MVP gamers 204 participating in the gaming events, and possibly even to viewers 210 of the gaming events. The compensation may be in the form of money, virtual currency, achievements, electronic gear, early access to new games, coupons, rebates, or other forms of awards or remuneration. When the compensation is in the form of achievements or a similar award that affects gaming status, this may be a way for MVP gamers 204/viewers 210 to further improve their gaming status.

Some embodiments of the present invention are directed to providing tutorials from MVP gamers 204 that other gamers may access. These tutorials may be provided by the MVP gaming system provider 202, and viewers 210 may be able to access the tutorials in a variety of different manners, including via their televisions, set-top boxes, computers, gaming consoles, or other devices. In some embodiments, the tutorials may be available via a channel created for televising gaming events 208 or an associated channel, although other approaches for accessing tutorials are contemplated as well. The avatars of sponsored MVP gamers 204 may be branded in the tutorials to promote the sponsors' brands.

In some embodiments, the tutorials may comprise videos that demonstrate MVP gamers 204 performing in certain game play. For instance, the tutorials may comprise video clips from past gaming events 208 (sanctioned and/or non-sanctioned gaming events) showing MVP gamers 204 completing certain actions. As another example, the tutorials may be specifically created by having the MVP gamers 204 perform some gaming activity either live or recording the gaming activity for subsequent viewing. These tutorial videos may also provide an interactive experience to viewers. For instance, viewers 210 may be able to control the viewpoint while watching the tutorials to view different perspectives.

In other embodiments of the present invention, the tutorials may provide an interactive experience by allowing gamers to play live with an MVP gamer 204. This may include the ability for a regular gamer to interact or learn from an MVP gamer 204 in 1-on-1 sessions. The MVP gamer 204 may then tutor the gamer on how to achieve certain goals within a game. This interaction between the gamer and the MVP gamer 204 would assist the gamer in achieving goals within a game. As a common scenario, the gamer may remain in the privacy of his/her own home and get the tutoring/advice when playing the game at home. The 1-on-1 tutorial could be real-time in-person or an online interaction where the MVP gamer 204 sees the gamer, how the gamer plays, and how the gamer reacts. The MVP gamer 204 could then advise accordingly. In some embodiments, the user may be able to record the sessions with the MVP gamer 204 and view the sessions at a later time. Although this above description discusses 1-on-1 tutorials, it's contemplated that an MVP gamer 204 may tutor multiple gamers at once and/or multiple MVP gamers 204 may tutor one or more gamers.

Another approach to tutorials may include providing a gamer with the ability to employ the “techniques” of an MVP gamer 204 during the gamer's game play. One of the things that makes an MVP gamer 204 a valuable player is not just game-provided “skills” (i.e., the abilities afforded to a player's avatar by the game system) but the techniques the MVP gamer 204 employs within the context of the game environment (e.g., controller movements, button presses, timing aspects, etc.). For instance, in the context of a first-person shooter game, pressing the “jump” button and the “turn right” button while “firing the laser blaster” may produce better results when facing certain types of opponents than simply aiming and firing. As can be understood from this example, it is the use of certain game system tools in particular ways that sets the MVP gamer's game play above the average gamer.

In accordance with some embodiments of the present invention, an MVP gamer's techniques may be packaged in “technique macros.” Each technique macro may comprise a number of user actions (i.e., controller movements, button pushes, timing aspects, etc.) that may be specific to a particular part of a game or may be employed at any time during a game. The technique macros may be provided to gamers, who may activate/execute the technique macros during the gamers' game play. When a technique macro is activated/executed, the actions contained in the macro are performed by the gamer's avatar in the game play. This may include providing the inputs to the game system associated with those actions. The technique macros may include any number of actions, including a single action, actions that complete a certain part of a level, actions that complete an entire level, or actions that complete an entire game.

In further embodiments, a tutorial may comprise an automated game play evaluation tool that breaks down the fundamental mechanics of a game and how MVP gamers 204 perform so well in terms of timing, pressing buttons, strategies or other techniques they use during the game. The evaluation tool can then automatically analyze a regular gamer's game play and suggest what the gamer needs to do different to emulate the mechanics of the MVP gamers 204. This provides particular advantages over simple tutorial videos, as watching someone do something and actually being told what to do is completely different. In particular, it may be difficult to capture all the nuisances of a game by simply watching another play the game.

The tutorials may be provided by different MVP gamers 204, and viewers 210 may be able to select tutorials from particular MVP gamers 204. Additionally, viewers 210 may be able to select from various tutorials directed to different types of game play. For instance, viewers 210 may select to tutorials from a particular category of games or a particular game title. Additionally, viewers 210 may select a tutorial corresponding with game play from certain parts of games. For instance, suppose a gamer is having difficulty in completing a certain part of a game. The gamer may be able to select a tutorial from the gamer's favorite MVP gamer 204 that assists the gamer in completing that part of the game.

MVP gamers 204 may receive compensation for the tutorials. In some embodiments, the compensation provided to an MVP gamer 204 may be based on the number of viewers watching the MVP gamer's 204 tutorials, the number of views of the MVP gamer's 204 tutorials, and/or other factors (e.g., the type of tutorials). The compensation may be in the form of money, virtual currency, achievements, electronic gear, early access to new games, coupons, rebates, or other forms of awards or remuneration. When the compensation is in the form of achievements or a similar award that affects gaming status, this may be a way for the MVP gamers 204 to further improve their gaming status.

Viewers 210 may also be charged a fee to access tutorials, and the cost of different tutorials may vary (e.g., based on popularity or other measures). The fee may be paid in the form of money, virtual currency, achievements, or other form. In some embodiments, the fee paid by viewers 210 may be provided to the MVP gamers as their compensation (either directly from viewers 210 to MVP gamers 204 or indirectly by being brokered by the system provider 202), although in other embodiments, the fees paid by viewers 210 to watch tutorials and the compensation to MVP gamers 204 may not have such a direct correlation. In some embodiments in which a tutorial assists a user in earning achievements, all or a portion of the achievements earned may be provided to the MVP gamer associated with the tutorial.

Further embodiments of the present invention are directed to allowing gamers to rent the avatar of MVP gamers 204 for use in game play. Avatar rentals may be facilitated by the MVP gaming system provider 202 and may include allowing other gamers to rent the look, skills, accessories, and/or techniques of an MVP gamer's 204 avatar. For instance, gamers may wish to have their avatars look like the avatars of their favorite MVP gamers 204 when they play games. Additionally, MVP gamers 204 may be afforded particular skill sets by the game system that become associated with their avatars, and gamers may wish to use those skill sets during game play. Further, MVP gamers 204 may acquire particular accessories that become associated with their avatars, and gamers may wish to use those accessories during game play. By way of example, the accessories could include certain weapons acquired by the MVP gamers 204 in first-person shooter games. Still further, as discussed above, the techniques of MVP gamers 204 may be captured in technique macros. In some embodiments, the technique macros may be provided as a feature of renting the avatar of an MVP gamer 204. It should be noted that, as used herein, an avatar's skills and techniques are distinct from one another. While skills are conferred upon an avatar and regulated by the gaming environment, techniques comprise an MVP gamer's 204 user actions within a game and may include the MVP gamer's 204 applications of skills afforded to the MVP gamer 204 by the game system.

When gamers rent avatars of MVP gamers 204, there may be restrictions placed on the game play. For instance, avatar rentals may not be allowed during sanctioned gaming events or other types of game play (e.g., online games). Additionally, since MVP gamer avatar rentals may provide gamers with special skills, accessories, and/or techniques the gamers don't typically have, the gamers may not be allowed to earn achievements when renting MVP gamer avatars. In other embodiments, the gamers may be allowed to earn achievements but may have to share all or a portion of the achievements with the MVP gamer whose avatar was being used.

For sponsored MVP gamers, the sponsor branding may be removed from the avatar when the avatar is rented. This may be at the discretion of the advertiser sponsoring the MVP gamer. In particular, some advertisers may prefer to have the branding removed during avatar rental, while other advertisers may prefer to have the branding included on the avatars during avatar rental to provide for further exposure of their brand.

MVP gamers 204 may receive compensation for rentals of their avatars. In some embodiments, the compensation provided to an MVP gamer 204 may be based on the number of gamers renting the MVP gamer's 204 avatar, the number of times of the MVP gamer's 204 avatar is rented, and/or other factors (e.g., what was rented—the avatar look, skill set, accessory). The compensation may be in the form of money, virtual currency, achievements, electronic gear, early access to new games, coupons, rebates, or other forms of awards or remuneration. When the compensation is in the form of achievements or a similar award that affects gaming status, this may be a way for the MVP gamers 204 to further improve their gaming status.

Gamers may also be charged a fee to rent MVP gamers' 204 avatars, and the cost of the rentals may vary (e.g., based on the MVP gamer; based on what is rented—the avatar look, skill set, or accessory). The fee may be paid in the form of money, virtual currency, achievements, or other form. In some embodiments, the fee paid by gamers may be provided to the MVP gamers 204 as their compensation (either directly from gamers to MVP gamers 204 or indirectly by being brokered by the system provider 202), although in other embodiments, the fees paid by gamers to rent the avatars and the compensation to MVP gamers 204 may not have such a direct correlation.

Viewers 210 may also be able to rate MVP gamers 204, and those ratings may be made available for public viewing. The ratings may be basic ratings, such as “like” or “dislike” or based on some scale. Ratings may also be provided for specific achievements or actions of the MVP gamers 204. Further, viewers 210 may provide ratings when accessing tutorials or renting an MVP gamer's 204 avatar based on the viewers' 210 experience. This information may be considered by other users when considering whether to access tutorials and/or rent avatars from certain MVP gamers 204.

In further embodiments, MVP gamers 204 may be able to set up an e-commerce/store front within the system. This may allow the MVP gamers 204 to advertise and sell various items, including real-world items (e.g., t-shirts, etc.) and gaming or virtual-world items (e.g., tutorials, avatar rentals, etc.).

Turning now to FIG. 3, a flow diagram is provided that illustrates an overall method 300 for providing MVP gaming in accordance with an embodiment of the present invention. Initially, as shown at block 302, a group of MVP gamers are identified. As discussed previously, MVP gamers may be identified in a number of different manners, including based on achievements earned during normal non-sanctioned gaming and/or by conducing sanctioned gaming events to identify the MVP gamers. Additionally, the group of gamers may be identified as having an MVP status in a particular type of games or a particular game title or series.

A sponsor for at least one of the MVP gamers is also identified, as shown at block 304. As indicated previously, sponsorship of MVP gamers by advertisers may be established in a number of different ways, and such sponsorship may be brokered by an MVP gaming system provider.

A gaming event is conducted at block 306 in which at least some of the gamers from the group of MVP gamers compete. This may include either a non-sanctioned or sanctioned gaming event. During the gaming event, the avatar of at least one sponsored MVP gamer is branded based on the sponsorship, as shown at block 308. Additionally, as shown at block 310, viewers are provided with the ability to watch the MVP gamers compete in the gaming event.

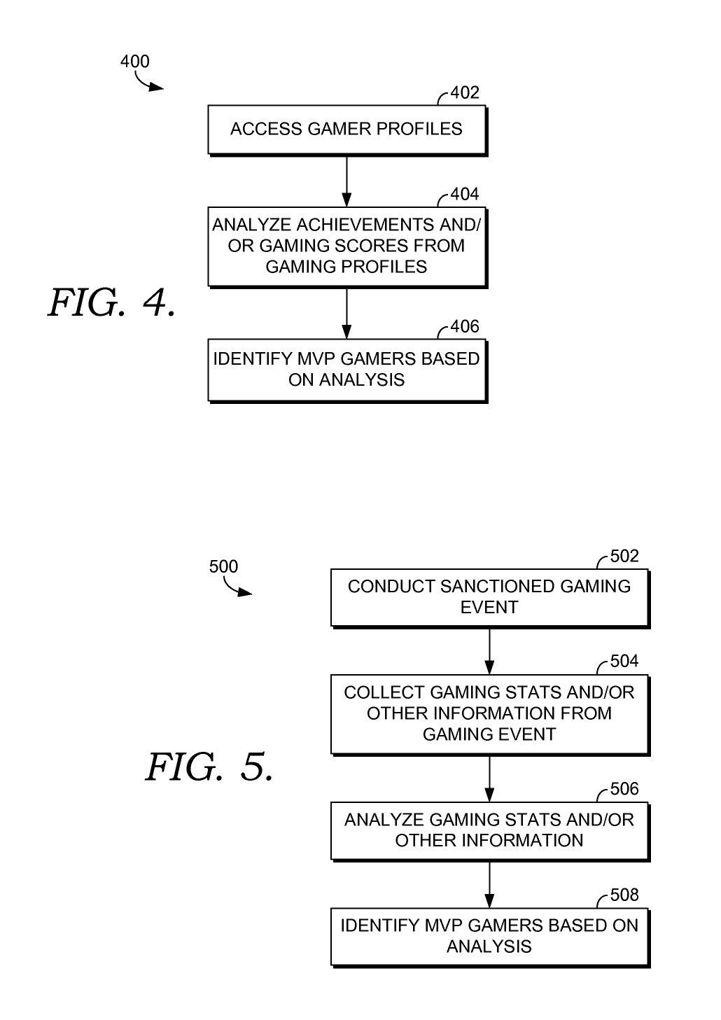

As discussed previously, gamers may be identified and awarded MVP status using any of a number of different approaches in various embodiments of the present invention. FIG. 4 illustrates a method 400 for using achievements and/or gaming scores to identify MVP gamers in accordance with an embodiment of the present invention. As shown at block 402, gamer profiles are accessed. Each gamer profile may include information for a gamer, including achievements the gamer has earned from playing various games and a gamer score that may be computed based on the achievements the gamer has earned.

The achievements, gamer scores, and/or other information from the gamer profiles are analyzed at block 404. Based on the analysis of information from the gamer profiles, MVP gamers are identified, as shown at block 406. The analysis of gamer profiles to identify MVP gamers may include consideration of various factors and information. For instance, in some embodiments, MVP gamers may be identified based on their total achievements or gamer scores. In some embodiments, MVP gamers may be identified within certain categories of games or within particular game titles or game series by analyzing information (e.g., achievements earned) within the categories of games, game titles, or game series. This may include, for instance, identifying games within the categories or game series, identifying achievements from those games, and awarding MVP status based on those achievements.

Turning now to FIG. 5, a flow diagram is provided that illustrates a method 500 for conducting a sanctioned event to identify MVP gamers in accordance with an embodiment of the present invention. Although FIG. 5 illustrates identification of MVP gamers from a single sanctioned gaming event, in some embodiments, multiple sanctioned gaming events may be held to identify MVP gamers.

As shown at block 502, a sanctioned gaming event is conducted in which gamers participate. In some embodiments, any gamer may participate in the sanctioned gaming event. In other embodiments, only certain gamers may be eligible to participate in the sanctioned gaming event. For instance, eligibility may be based no gamers achievements and/or gaming score from non-sanctioned gaming.

Gaming stats for the gamers are collected during the gaming event, as shown at block 504. Other information may also be collected during the gaming event. For instance, if the gaming event is being watched by viewers, information regarding which gamers are being watched by viewers may be collected.

The gaming stats and/or other information collected during the gaming event are analyzed, as shown at block 506. Based on analysis of the gaming stats and/or other information, MVP gamers are identified, as shown at block 508. In some embodiments, the sanctioned gaming event may be directed to a particular category of games, game title, or game series. If so, the gamers may be awarded MVP status in only that particular game category, game title, or game series. Other sanctioned events could be conducted in other categories, game titles, or game series that could allow gamers to compete in an attempt to obtain MVP status in those other categories, game titles, or game series.

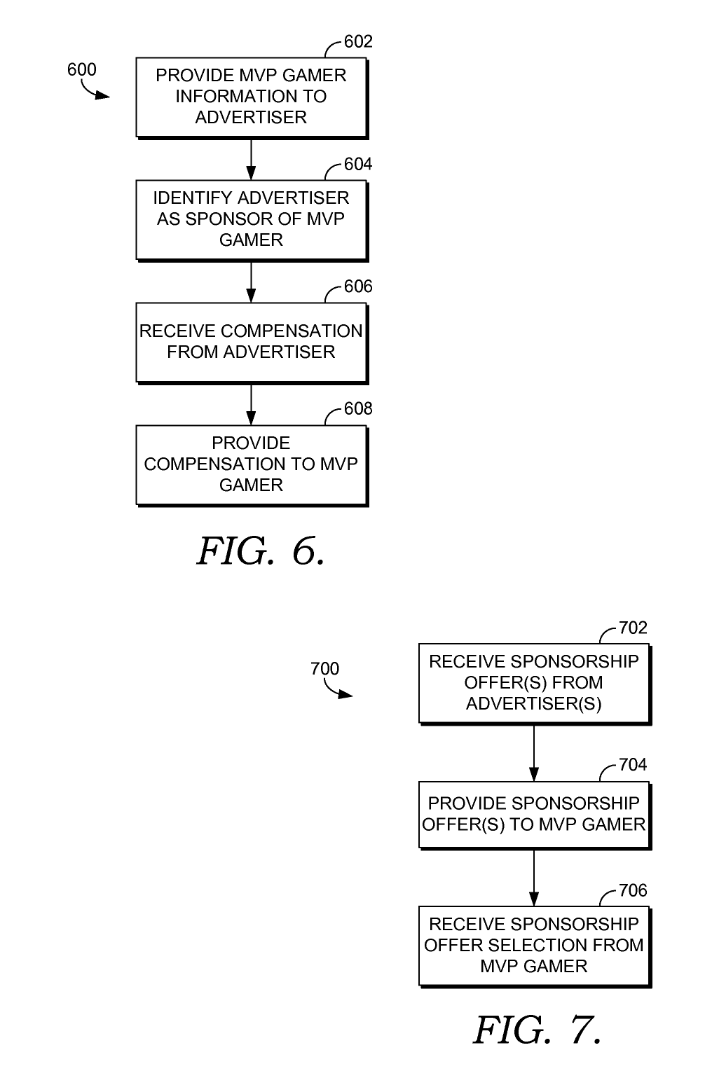

As discussed previously, in some embodiments, advertisers may sponsor MVP gamers, and such sponsorship may be brokered by an MVP gaming system provider. Referring to FIG. 6, a flow diagram is provided that illustrates a method 600 for coordinating sponsorship of MVP gamers by advertisers in accordance with an embodiment of the present invention. As shown at block 602, information regarding an MVP gamer is provided to an advertiser. In practice, information for multiple MVP gamers may be provided to multiple advertisers to allow the advertisers to review the information and determine which MVP gamers to sponsor. The information provided may include gaming stats and other gaming-related information, such as achievements earned or gamer score. The information may also include viewership information for the MVP gamer from “televised” gaming events, such as information indicative of the number of viewers, number of views, and/or length of viewing. The information provided to advertisers may also include information regarding other gamers' access to an MVP gamer's tutorials or information regarding other gamers' rental of an MVP gamer's avatar, including rental of the avatar's look, skills, and/or accessories. Other information may also be provided to the advertisers in embodiments of the present invention.

The advertiser may review the MVP gamer information and decide to sponsor the MVP gamer. As such, the advertiser may be identified as a sponsor of the MVP gamer, as shown at block 604. As part of brokering the sponsorship and/or otherwise providing the MVP gaming system, the MVP gaming system provide may receive compensation from the advertiser for the opportunity to sponsor the MVP gamer, as shown at block 606. Additionally, compensation may be provided to the MVP gamer for the sponsorship, as shown at block 608. The compensation to the MVP gamer may be in the form of money, virtual currency, achievements, electronic gear, early access to new games, coupons, rebates, or other forms of awards or remuneration.

The sponsorship relationship between an advertiser and an MVP gamer may be formed in a number of different ways within the scope of embodiments of the present invention. In some embodiments, after reviewing the MVP gamer information, the advertiser may simply select to sponsor the MVP gamer, thereby creating a sponsorship relationship. In other embodiments, various advertisers may bid on the opportunity to sponsor the MVP gamer with the highest bidder(s) winning the ability to sponsor the MVP gamer.

In further embodiments, the advertisers may submit sponsorship offers, which may be provided to the MVP gamer who may review and select from the sponsorship offers. Again, this approach for creating sponsorships may be brokered by the MVP gaming system provider. With reference to FIG. 7, a flow diagram is provided that illustrates a method 700 for coordinating sponsorship offers between advertisers and an MVP gamer in accordance with an embodiment of the present invention.

As shown at block 702, sponsorship offers are received from one or more advertisers. Each sponsorship offer may include an indication of the advertiser providing the offer, as well as details of the proposed sponsorship (e.g., compensation the advertiser may provider to the MVP gamer and/or the MVP gaming system provider). As shown at block 704, the sponsorship offers are provided to the MVP gamer who may review the details of the offers. In some instances, the MVP gamer may select a particular sponsorship offer, and the MVP gamer's selection is received, as shown at block 708. In other instances, the MVP gamer may decline the offers, and/or the MVP gamer may decide to submit counteroffers to one or more of the advertisers. If the MVP gamer submits a counteroffer, the counteroffer may be provided to the corresponding advertiser who may decide to accept or reject the counteroffer or decide to further negotiate.

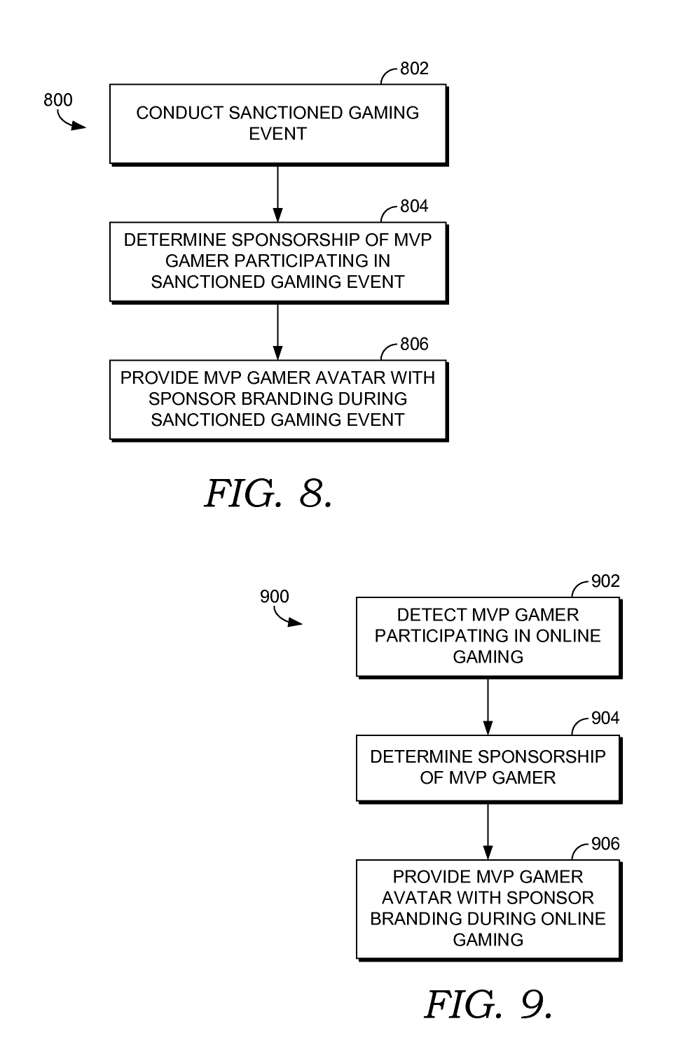

As discussed previously, sponsorship of MVP gamers may include branding the MVP gamers' avatars during game play. This may include branding during sanctioned gaming events and non-sanctioned online gaming. Turning now to FIG. 8, a flow diagram is provided that illustrates a method 800 for branding an MVP gamer's avatar during a sanctioned gaming event in accordance with an embodiment of the present invention. As shown at block 802, a sanctioned gaming event is conducted in which a particular MVP gamer participates. The sponsorship of the MVP gamer participating in the sanctioned gaming event is determined, as shown at block 804. Based on the sponsorship of the MVP gamer, the MVP gamer's avatar is branded during the sanctioned gaming event, as shown at block 806. In some embodiments, the MVP gamer may be sponsored by multiple advertisers. In some instances, only a single advertiser's branding may be included in any given gaming event. The advertiser for a given event may be selected from the multiple sponsors for the MVP gamer at random, based on sponsorship for the given event, or based on some other selection method. In other instances, the MVP gamer's avatar may be branded with each of the multiple sponsors for the MVP gamer.

With reference now to FIG. 9, a flow diagram is provided that illustrates a method 900 for branding an MVP gamer's avatar during an online non-sanctioned gaming event in accordance with an embodiment of the present invention. As indicated previously, non-sanctioned gaming events may simply comprise traditional online gaming in which any gamer may participate. When MVP gamers participate in such online gaming, advertisers sponsoring the MVP gamers may wish to have the MVP gamers' avatars branded during the gaming so other gamers may see the branding. Accordingly, as shown at block 902, an MVP gamer participating in an online gaming event is detected. This may occur, for instance, when the MVP gamer logs into the MVP gamer's gaming account and selects to play an online game.

The sponsorship of the MVP gamer participating in the non-sanctioned online gaming event is determined, as shown at block 904. Based on the sponsorship of the MVP gamer, the MVP gamer's avatar is branded during the non-sanctioned online gaming event, as shown at block 906. In some embodiments, the MVP gamer may be sponsored by multiple advertisers. In some instances, only a single advertiser's branding may be included in any given gaming event. The advertiser for a given event may be selected from the multiple sponsors for the MVP gamer at random, based on sponsorship details, or based on some other selection method. In other instances, the MVP gamer's avatar may be branded with each of the multiple sponsors for the MVP gamer.

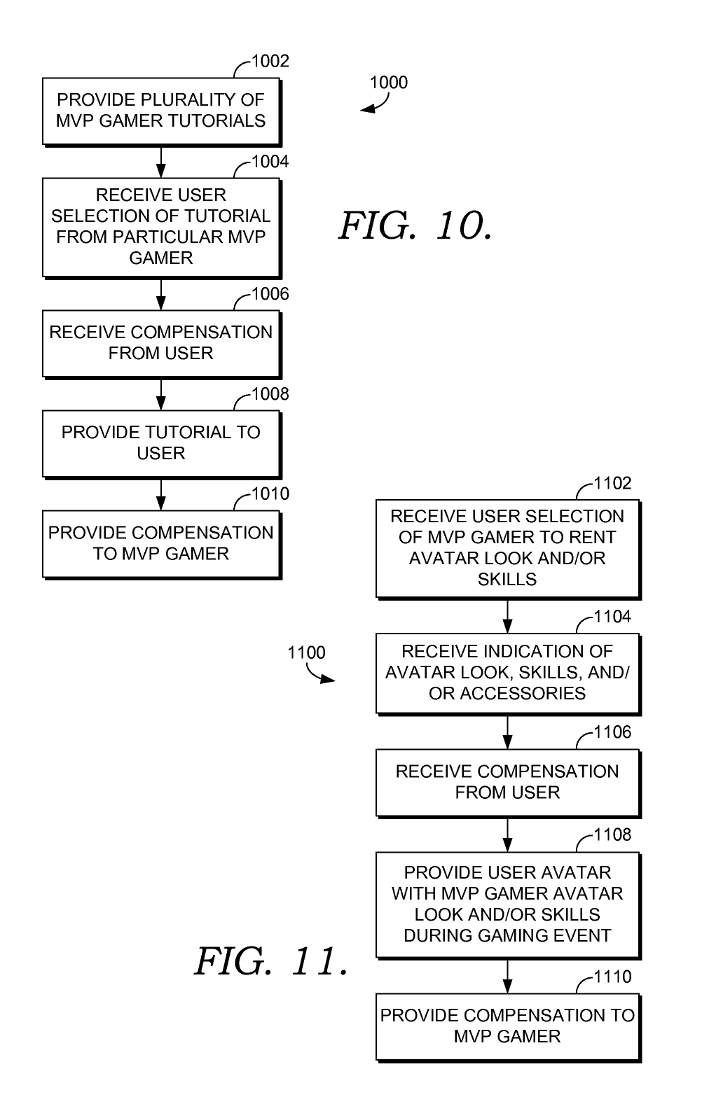

As discussed previously, some embodiments are directed to providing tutorials from MVP gamers. Referring to FIG. 10, a flow diagram is provided that illustrates a method 1000 for providing an MVP gamer tutorial in accordance with an embodiment of the present invention. As shown at block 1002, a plurality of MVP gamer tutorials is provided. The tutorials may be provided from a number of different MVP gamers, involve a number of different games, and may be directed to different levels or parts of various games. Additionally, a number of different types of tutorials may be provided, such as video tutorials, interactive game sessions with MVP gamers, technique macros, and evaluation tools.

A user selection of a tutorial from a particular MVP gamer is received, as shown at block 1004. For instance, in some embodiments, a user interface that allows users to browse and/or search tutorials based on MVP gamer and/or tutorial type (e.g., game category, game title or series, game level, or other identifying feature). The selected tutorial may comprise game play by the MVP gamer that was recorded from a previous sanctioned or non-sanctioned gaming event. Alternatively, the selected tutorial may be game play that was performed by the MVP gamer solely for the purpose of creating the tutorial. In some embodiments, the tutorial may comprise the opportunity to play live with the MVP gamer, thereby allowing the user to learn how to perform certain skills, complete certain game levels, or otherwise just be able to experience playing with the MVP gamer In further embodiments, the tutorial may be a technique macro that the MVP gamer may execute during game play. In still further embodiments, the tutorial may be an evaluation tool that evaluates the gamer's game play relative to an MVP gamer's game play to provide suggestions. Other types of tutorials from MVP gamers may also be provided to assist the gamer.

Compensation is received from the user, as shown at block 1006. For instance, the user may be required to compensate the MVP gaming system provider or other entity providing the tutorial service. In some embodiments, the tutorial may be provided as part of a membership fee or other fee program. For instance, the user may have membership to a gaming-related service (e.g., the XBOX LIVE service) or subscription to a channel televising gaming events, and a tutorial service or a number of tutorials may be included as part of the fees for those other services.

As shown at block 1008, the tutorial is provided to the user. The user may be provided the tutorial in a number of different methods via a number of delivery channels. In some embodiments, the tutorial may be interactive. For instance, the user may be able to change the perspective (view, zoom, etc.) of the game play in the tutorial or portion of the tutorial being viewed. The user may also be able to view the tutorial in context of the user's own game play. This could allow, for instance, the user to follow the MVP gamer's play from the tutorial during the user's own game play. As noted above, further embodiments are directed to tutorials in which the user is given the ability to play a live game with the MVP gamer, employ an MVP gamer's techniques (e.g., via a technique macro), or employ an evaluation tool to evaluate their game play.

Compensation for the tutorial is provided to the MVP gamer at block 1010. In some embodiments, the MVP gamer may be compensated as a function of the number of viewers accessing the MVP gamer's tutorials. In such embodiments, tutorial viewing information may be collected, and the MVP gamer's compensation for the tutorials may be calculated based on the tutorial viewing information. This could be done on a periodic basis. In other embodiments, the MVP gamer may be compensated for the tutorials regardless of viewing access to the tutorials. The MVP gamer's compensation be in the form of money, virtual currency, achievements, electronic gear, early access to new games, coupons, rebates, or other forms of awards or remuneration.

As also discussed previously, further embodiments are directed to allowing gamers to rent MVP gamer's avatars during game play. This may include renting the MVP gamer's avatar look, skills, accessories, and/or techniques. Turning now to FIG. 11, a flow diagram is provided that illustrates a method 1100 for renting an MVP gamer's avatar in accordance with an embodiment of the present invention. As shown at block 1102, a user selection of an MVP gamer avatar the user wishes to rent is received. Additionally, as shown at block 1104, an indication of whether the user wishes to rent the MVP gamer avatar's look, skills, accessories, and/or techniques is received. For instance, the user may be provided a user interface that allows the user to browse and/or search various MVP gamers and their avatars and select an MVP gamer avatar for rental. In some embodiments, the user may be able to select from a number of different visible features, different skills, different accessories, and/or different techniques available from the MVP gamer's avatar.

Compensation is received from the user, as shown at block 1106. For instance, the user may be required to compensate the MVP gaming system provider or other entity providing the avatar rental service. In some embodiments, the avatar rental service may be provided as part of a membership fee or other fee program. For instance, the user may have membership to a gaming-related service (e.g., the XBOX LIVE service) or subscription to a channel televising gaming events, and an MVP rental service may be included as part of the fees for those other services.

As shown at block 1108, the MVP gamer avatar's look, skills, accessories, and/or techniques are provided to the user's avatar during the user's game play. As such, the user's avatar may look like the MVP gamer's avatar, the user may employ the MVP gamer avatar's skills, the user may employ the MVP gamer avatar's accessories, and/or the user may employ the MVP gamer's techniques during the user's game play.

Compensation for rental of the MVP gamer's avatar is provided to the MVP gamer at block 1110. In some embodiments, the MVP gamer may be compensated as a function of details of the avatar rentals (e.g., the number of times the MVP gamer's avatar is rented, what features were rented, how long the avatar was rented, etc.). In such embodiments, avatar rental information may be collected, and the MVP gamer's compensation for the avatar rentals may be calculated based on the rental information. This could be done on a periodic basis. In other embodiments, the MVP gamer may be compensated for the avatar rentals regardless of such rental information. The MVP gamer's compensation be in the form of money, virtual currency, achievements, electronic gear, early access to new games, coupons, rebates, or other forms of awards or remuneration.

As can be understood, embodiments of the present invention provide an MVP gaming system environment in which MVP gamers may be identified and sponsored in various gaming events. Additionally, embodiments provide for tutorials from MVP gamers and rental or MVP gamer avatars. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. A method for providing a gaming event with most valuable player (MVP) gamers, the method comprising:
identifying one or more MVP gamers;
identifying a sponsor for a first MVP gamer;
conducting a gaming event with the one or more MVP gamers; and
branding an avatar of the first MVP gamer during the gaming event based on the sponsor.

2. The method of claim 1, wherein identifying the one or more MVP gamers comprises:
accessing gamer profiles for a plurality of gamers, each gamer profile containing information regarding at least one of achievements or a gamer score earned by a gamer;
analyzing the gamer profiles; and
identifying the one or more MVP gamers based on analysis of the gamer profiles.

3. The method of claim 1, wherein identifying the one or more MVP gamers comprises:
conducting a sanctioned gaming event in which a plurality of gamers participate;
collecting gaming stats for each of the plurality of gamers during the sanctioned gaming event;
analyzing the gaming stats from the sanctioned gaming event; and
identifying the one or more MVP gamers based on analysis of the gaming stats from the sanctioned gaming event.

4. The method of claim 1, wherein each of the one or more MVP gamers is identified as having an MVP status in at least one selected from the following: a category of gamers, a game title, and a game series.

5. The method of claim 1, wherein identifying the sponsor for the first MVP gamer comprises:
providing information regarding the first MVP gamer to a plurality of advertisers;
receiving from a first advertiser an indication to sponsor the first MVP gamer; and
identifying the first advertiser as the sponsor for the first MVP gamer.

6. The method of claim 5, wherein the information regarding the first MVP gamer provided to the plurality of advertisers comprises: gaming stats, viewer information, tutorial information, and avatar rental information.

7. The method of claim 1, wherein identifying the sponsor for the first MVP gamer comprises:
providing information regarding the first MVP gamer to a plurality of advertisers;
receiving a sponsorship offer from a first advertiser;
providing the sponsorship offer to the first MVP gamer;
receiving an acceptance of the sponsorship offer from the first MVP gamer; and
identifying the first advertiser as the sponsor for the first MVP gamer.

8. The method of claim 1, wherein the gaming event comprises a sanctioned gaming event involving a game specially developed for sanctioned gaming.

9. The method of claim 1, wherein the gaming event comprises an online gaming event that includes one or more non-MVP gamers.

10. The method of claim 1, wherein the method further comprises: making the gaming event available for viewing by a plurality of viewers that are not participating in the gaming event.

11. The method of claim 10, wherein making the gaming event available for viewing comprises televising the gaming event on a channel dedicated to gaming.

12. The method of claim 10, wherein making the gaming event available for viewing comprises providing an interactive experience in which a viewer may control a viewing perspective.

13. One or more computer-storage media storing computer-useable instructions that, when used by one or more computing devices, cause the one or more computing devices to perform a method, the method comprising:
providing a plurality of tutorials, each tutorial corresponding with at least one of a plurality of most valuable player (MVP) gamers;
receiving, from a user, a request for a first tutorial, the first tutorial corresponding with a first MVP gamer; and
providing the requested first tutorial to the user.

14. The one or more computer-storage media of claim 13, wherein the plurality of tutorials comprise: at least one tutorial created from a previous gaming event; at least one tutorial created for the purpose of providing the tutorial; at least one tutorial that comprises an opportunity to play with at least one MVP gamer; at least one tutorial that comprises a technique macro, and at least one tutorial that comprises an evaluation tool that evaluates the user's game play relative to an MVP gamer's game play.

15. The one or more computer-storage media of claim 13, wherein the first tutorial provides an interactive experience in which the viewer may control a viewing perspective.

16. The one or more computer-storage media of claim 13, wherein the method further comprises collecting tutorial viewing information for the purpose of compensating the first MVP gamer based on tutorial viewing.

17. One or more computer-storage media storing computer-useable instructions that, when used by one or more computing devices, cause the one or more computing devices to perform a method, the method comprising:
receiving a user selection of an avatar of a most valuable player (MVP) gamer to rent during gaming; and
providing the gamer with the avatar of the MVP gamer during the gaming.

18. The one or more computer-storage media of claim 17, wherein providing the gamer with the avatar of the MVP gamer during the gaming comprises providing at least one selected from the following: a look of the avatar of the MVP gamer, a skill of the avatar of the MVP gamer, an accessory of the avatar of the MVP gamer, and a technique of the avatar of the MVP gamer.

19. The one or more computer-storage media of claim 17, wherein the method further comprises placing a restriction during the gaming based on rental of the avatar of the MVP gamer, wherein the restriction comprises on or more selected from the following: preventing user of the avatar of the MVP gamer during particular types of game play, and preventing the gamer from earning achievements during the gaming.

20. The one or more computer-storage media of claim 17, wherein the method further comprises collecting avatar rental information for the purpose of compensating the first MVP gamer based on rental of the avatar of the MVP gamer.
